(19) United States
(12) Patent Application Publication
(10) Pub. No.: US 2024/0046353 A1
(43) Pub. Date: Feb. 8, 2024

(54) DIGITAL WORKBENCH FOR TRADE FINANCE OPERATION

(71) Applicant: CLEARTRADE AI, INC., Ladera Ranch, CA (US)

(72) Inventors: Mariya George, Ladera Ranch, CA (US); Chandrasekhar Somasekhar, Ladera Ranch, CA (US); Sarath Sasikumar, Ladera Ranch, CA (US)

(73) Assignee: Cleartrade.ai, Inc., Ladera Ranch, CA (US)

(21) Appl. No.: 18/270,541

(22) PCT Filed: Sep. 14, 2022
(86) PCT No.: PCT/US22/43401

§ 371 Date: Jun. 30, 2023

Related U.S. Application Data
(60) Provisional application No. 63/254,533, filed on Oct. 12, 2021.

(51) Int. Cl. G06Q 40/04

(52) U.S. Cl. CPC G06Q 40/04

(57) ABSTRACT

A computer-implemented system and method for trade finance operation and screening is disclosed. The system comprises a computing device having a processor and a memory in communication with the processor; one or more databases in communication with the computing device via a network to store a plurality of trade finance transaction documents; and a user device associated with a user in communication with the computing device via the network to perform finance operations and sanctions screening. The system classifies a plurality of trade finance transaction documents uploaded under different groups/categories. The classified documents are previewed and reclassified as per LC details. The system then verifies the system-extracted information from the uploaded documents. The documents are validated using one or more rules to provide document scrutinization results based on UCP/ISBP/Consistency rule checks, thereby performing automated reconciliation against UCP and ISBP rules and seamlessly integrate with sanctions screening and TBML systems.

### CROSS REFERENCE TO RELATED APPLICATIONS

The present application claims the benefit of PCT Application PCT/US22/43401 filed Sep. 14, 2022 which further claims the benefit of U.S. Patent Application No. 63/254,533 filed Oct. 12, 2021, entitled “Digital Workbench for Trade Finance Operation” the contents of which is hereby incorporated by reference.

### BACKGROUND OF THE INVENTION

### A. Technical Field

The present invention generally relates to trade financing services. More specifically, the present invention relates to a system and method for trade finance operations and sanctions screening process, thereby improving the effectiveness and efficacy of trade finance operations.

### B. Description of Related Art

The financial service industry performs trade finance operations to facilitate international trade and commerce. It is possible and easier for financial service industries such as banks, trade finance companies, importers and exporters, agencies, and service providers to transact business through trade finance. The major function of trade finance is to remove the payment risk and the supply risk during transactions.

In today's global market, the financial service industries utilize several financial applications to process financial transactions, financial information, and sanction screening processes. These financial service industries establish a centralized system for processing financial applications and other financial data. The number of financial transactions and financial information used by financial service providers has grown at a staggering rate. At the same time, the need to manage and analyze the data from different financial applications has become essential.

Typically, trade finance powers more than 80% of the world's international trade. However, it is also increasingly identified as a potential conduit for money laundering and vulnerable to a breach of sanctions regulations. Stringent regulatory scrutiny and compliance requirements leave banks exposed to significant operational risks in terms of reputational damages and fines.

Many existing systems use various systems and methods of processing digital financial transactions through Artificial intelligence (AI) to overcome such drawbacks. Few existing patent references attempt to address the problems cited in the background as prior art over the presently disclosed subject matter are explained as follows:

A prior art WO 2021231408 A1 to James Toffey, et. al., entitled “Systems and methods for digitization and trading of trade finance assets” discloses methods and systems include a trade finance digital asset platform that generally provides improved visibility, security, and workflow execution for a set of trade finance transactions enabling capabilities for trade finance asset digitization, a trade finance data object model, interfaces to systems used by parties to trade finance transactions, event and state reporting services, and smart contract services that optionally operate using a blockchain.

Another prior art U.S. Ser. No. 10/628,828 B2 to Jose Caldera, entitled “Systems and methods for sanction screening” discloses a computerized sanction screening system may include an automated system for collection of sanction information, and a routine for analyzing additional available data related to sanction information entities. The system may also include an automated analysis summary routine for creating condensed information subsets or graphlets containing relevant information about sanction entities, some of which can be entities themselves, organized in a data retrieval system, such that an automated transaction system can check data from transactions and automatically identify and flag potentially sanctioned transactions. Then upon exceeding a preset contextual limit, a potential blocking warning is issued.

Yet another prior art U.S. Ser. No. 10/109,010 B2 to Denis Ignatovich, et. al., entitled “System and method for modeling and verifying financial trading platforms” discloses a computer-implemented method assesses operation of a financial computing system (FCS). An assessment computer system generates code for a model of the FCS that comprises a model specification for the FCS and a model environment for the FCS. The code for the model uses a type-system based logical programming language that supports typed recursive functions. The assessment computer system generates mathematical axioms that describe the operation of the FCS by compiling the code for the model and assesses the operation of the financial computer system by analyzing the mathematical axioms.

These existing systems are mainly used in limiting financial business losses but do not increase the efficiency and accuracy of the financial transactions at a high level. Also, there is no standard way of mentioning Goods and services along with the metadata ex, price, HS Code, incoterms etc. In addition, extracting goods/services and its metadata from Invoices, and packing list is complex due to the lack of a standard template or table structure that is followed across trade documents. Further, description of Goods and services may not follow the same wordings across documents. While it comes naturally for a human to interpret it as the same, for an automated solution it's a challenging task.

Therefore, there is a need for a digital solution to process trade finance transaction documents and to perform automated validation and reconciliation of the information present in the documents. Also, there is a need for a system to improve risk coverage and compliance level. This helps to reduce the risk by reconciling the financial information of the exporter and importer.

### SUMMARY OF THE INVENTION

The present invention discloses a system and method for trade finance operations and sanctions screening process, thereby improving the effectiveness and efficacy of trade finance operations. Also, the present invention discloses a digital solution to process the trade finance transaction documents for automated validation and reconciliation of the information present in the documents. Further, the present invention discloses a system to improve risk coverage and compliance level, which helps in reducing the risk by reconciling the financial information of the exporter and importer.

In one embodiment, the system is configured to perform trade finance operations and sanctions screening processes. In one embodiment, the system is an innovative and intelligent computer-implemented solution that has been designed to allow a bank or transactional entity to effectively and efficiently perform the trade finance operations and sanctions screening processes for their clients. The system enables the clients to reduce risks, improve throughput, and significantly reduce false positives and missed red flags. In one embodiment, the system improves throughput up to 70%. In one embodiment, the system is a digital workbench to process trade finance transaction documents. In one embodiment, the system is configured to perform automated reconciliation against UCP and ISBP rules and seamlessly integrate with sanctions screening and trade-based money laundering (TBML) systems.

In one embodiment, the system is an application software or mobile application or web-based application. In one embodiment, the application is executed in the computer-implemented environment or network environment. In one embodiment, the computer-implemented environment comprises a user device and a trade finance transaction management system. The user device is associated with a user or maker or banker. The user device is enabled to access the trade finance transaction management system via a communication network. In one embodiment, the user device is at least any one of a smartphone, a mobile phone, a laptop, a desktop, a tablet, or other suitable mobile and/or handheld electronic communication devices.

In one embodiment, the trade finance transaction management system comprises a computing device and one or more databases. In one embodiment, the user device comprises a storage medium in communication with the network to access the computing device via the network configured to perform finance operations and sanctions screening operations. In one embodiment, the user is allowed to register into the system using one or more user credentials configured to access the services provided by the computing device. In an embodiment, the network may be a Wi-Fi network, a WiMAX network, a local area network (LAN), a wide area network (WAN), and a wireless local area network (WLAN). In one embodiment, the database is in communication with the computing device via the network configured to store a plurality of trade finance transaction documents.

In one embodiment, the computing device comprises at least one processor and a memory in communication with the processor. The memory stores a set of instructions executable by the processor. In one embodiment, the computing device may be a server or cloud server. The server is configured to collect one or more parameters from the user device. In one embodiment, the server may be operated as a single computer. In some embodiments, the computer could be a touchscreen and/or non-touchscreen and adopted to run on any type of OS, such as iOS™, Windows™, Android™, Unix™, Linux™, and/or others. In one embodiment, the plurality of computers is in communication with each other, via the network. Such communication is established via a software application, a mobile app, a browser, an OS, and/or any combination thereof.

In one embodiment, the computing device receives the trade finance transaction documents uploaded by the user or any of transactional entities via the network configured to classify the trade finance transaction documents under different groups/categories using at least one artificial intelligence (AI) classifier; preview each page of the document as per letter of credit (LC); verify the system extracted information from the uploaded documents, and validate one or more rules for each document to provide document scrutinization results based on Uniform Customs and Practice (UCP)/International Standard Banking Practice (ISBP)/Consistency rule checks, thereby performing automated reconciliation against UCP and ISBP rules and seamlessly integrate with sanctions screening and Trade Based Money Laundering (TBML) systems.

In one embodiment, the documents are reclassified to any of the other existing groups or a new group. In one embodiment, the system further performs completeness check for various documents requested or received by the user or other transactional entities under different fields. In one embodiment, the different fields include bill of exchange, commercial invoice, bill of lading, packing list, certification of origin, beneficiary's, and unclassified. In one embodiment, the system further utilizes rubber banding or smart data capture configured to eliminate the need for any manual typing to capture missing information from the actual document. In one embodiment, the system compares each document with the LC details, which allows the user to cross-verify the contents of the document against the values in the LC from the same page. In one embodiment, the system generates a discrepancy report for the respective LC and associated trade documents and exports the discrepancy report in a standard format. In one embodiment, the system provides the rules authoring capability to any user that gives more transparency towards the rules executed in the context of trade document scrutinization. In one embodiment, the system further includes a profile comprising a representation of task history of a corresponding transactional entity.

In one embodiment, a method for trade finance operations and sanctions screening executed using a system in a computer-implemented environment is disclosed. In one embodiment, the system is an application software or mobile application or web-based application. In one embodiment, the application is executed in the computer-implemented environment or network environment. In one embodiment, the computer-implemented environment comprises a user device and a trade finance transaction management system. The user device is associated with a user or maker or banker. The user device is enabled to access the trade finance transaction management system via a communication network. In one embodiment, the trade finance transaction management system comprises a computing device and one or more databases. In one embodiment, the user device comprises a storage medium in communication with the network to access the computing device via the network configured to perform finance operations and sanctions screening operation. In one embodiment, the computing device comprises at least one processor and a memory in communication with the processor. The memory stores a set of instructions executable by the processor.

In one embodiment, the method comprises the following steps. At one step, the user log in/sign in to enter in to the application using one or more user credentials such as email and password upon successful registration. At another step, the system classifies a plurality of trade finance transaction documents uploaded under different groups/categories. At another step, the system allows the user to preview each page of the document as per letter of credit (LC). At another step, the documents are reclassified under any of the other existing groups or a new group. At another step, the system enables the user to verify the system extracted information from the uploaded documents. In one embodiment, the system compares each document with LC that allows the user to cross-verify the contents of the document against the values in the LC from the same page. At another step, one or more rules are validated for each document to provide document scrutinization results based on Uniform Customs and Practice (UCP)/International Standard Banking Practice (ISBP)/Consistency rule checks, thereby performing automated reconciliation against UCP and ISBP rules and seamlessly integrate with sanctions screening and Trade Based Money Laundering (TBML) systems.

In one embodiment, the documents are reclassified to any of the other existing groups or a new group. In one embodiment, the method further performs completeness check for various documents requested or received by the user or other transactional entities under different fields. In one embodiment, the method further utilizes rubber banding or smart data capture configured to eliminate the need for any manual typing to capture missing information from the actual document. In one embodiment, the method compares each document with LC and allows the user to cross-verify the contents of the document against the values in the LC from the same page. In one embodiment, the method further generates a discrepancy report for the respective LC and associated trade documents and exports the discrepancy report in a standard format. In one embodiment, the method further provides the rules authoring capability to any user to provide more transparency towards the rules executed in the context of trade document scrutinization.

According to the present invention, the system leverages advanced artificial intelligence (AI) techniques to improve the effectiveness and efficiency of the trade finance operations and sanctions screening processes. The system enables the clients to reduce risks, improve throughput by up to 70% and significantly reduce false positives and missed red flags. The system performs an automated classification, extraction, and validation of information from low fidelity scanned images or documents using layout and position-based learning. The system performs automated interpretation of letter of credit (LC) conditions using natural language processing (NLP). The system automates the reconciliation against UCP and ISBP. The improved transaction increases the productivity to about 70% and significantly reduces the false positives in sanctions screening. Further, the system drastically reduces the missed red flags in TBML checks and improves the risk coverage and compliance level.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a block diagram of a system executed in a computer-implemented environment in an embodiment of the present invention.

FIG. 2 shows a method for trade finance operations and sanctions screening in one embodiment of the present invention.

FIG. 3 shows a screenshot of a dashboard in one embodiment of the present invention.

FIG. 4 shows a screenshot of a plurality of tasks in one embodiment of the present invention.

FIG. 5. shows a screenshot for task confirmation in one embodiment of the present invention.

FIG. 6 shows a screenshot of an assigned task in one embodiment of the present invention.

FIG. 7 shows an example screenshot of LC details having LC extracted data and LC original data in one embodiment of the present invention.

FIG. 8 shows a screenshot of a bill of lading of the assigned task in one embodiment of the present invention.

FIG. 9 shows a screenshot of a reclassification of the assigned task in one embodiment of the present invention.

FIGS. 10-11 show one or more screenshots of the reclassification of the assigned task under different groups in one embodiment of the present invention.

FIGS. 12-13 show one or more screenshots of an example for original data of bill of lading in one embodiment of the present invention.

FIG. 15 shows a screenshot for a bill of exchange under extraction in one embodiment of the present invention.

FIGS. 16-17 show one or more screenshots for filling extracted bill data and the bill of exchange using the smart data capture technique in one embodiment of the present invention.

FIG. 18 shows a screenshot of rules validation in one embodiment of the present invention.

FIG. 19 shows a screenshot of a comparison table in one embodiment of the present invention.

FIG. 20 shows an example screenshot of rules validation in one embodiment of the present invention.

FIG. 21 shows an example screenshot of the explainability view in one embodiment of the present invention.

FIGS. 22-24 show one or more screenshots of a discrepancy report in one embodiment of the present invention.

FIGS. 25-26 show one or more screenshots for highlighting passed/failed conditions in one embodiment of the present invention.

FIG. 27 shows a screenshot of the rules configuration in one embodiment of the present invention.

FIG. 28 shows a screenshot for adding a new rule in one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

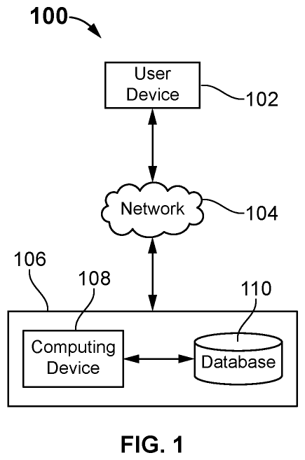

Referring to FIG. 1, a block diagram of a system executed in a computer-implemented environment 100, according to one embodiment of the present invention. The system is configured to perform trade finance operations and sanctions screening process. In one embodiment, the system is an innovative and intelligent computer-implemented solution that has been designed to allow a bank or transactional entity to effectively and efficiently perform the trade finance operations and sanctions screening processes for their clients. The system enables the clients to reduce risks, improve throughput, and significantly reduce false positives and missed red flags. In one embodiment, the system improves throughput up to 70%. In one embodiment, the system is a digital workbench to process trade finance transaction documents. In one embodiment, the system is configured to perform automated reconciliation against UCP and ISBP rules and seamlessly integrate with sanctions screening and trade-based money laundering (TBML) systems.

In one embodiment, the system is an application software or mobile application or web-based application. In one embodiment, the application is executed in the computer-implemented environment or network environment 100. In one embodiment, the computer-implemented environment 100 comprises a user device 102 and a trade finance transaction management system 106. The user device 102 is associated with a user or maker or banker. The user device 102 is enabled to access the trade finance transaction management system 106 via a communication network 104. In one embodiment, the user device 102 is at least any one of a smartphone, a mobile phone, a laptop, a desktop, a tablet, or other suitable mobile and/or handheld electronic communication devices.

In one embodiment, the trade finance transaction management system 106 comprises a computing device 108 and one or more databases 110. In one embodiment, the user device 102 comprises a storage medium in communication with the network 104 to access the computing device 108 via the network 104 configured to perform finance operations and sanctions screening operation. In one embodiment, the user is allowed to register into the system using one or more user credentials configured to access the services provided by the computing device 108. In an embodiment, the network 104 may be a Wi-Fi network, a WiMAX network, a local area network (LAN), a wide area network (WAN), and a wireless local area network (WLAN). In one embodiment, the database 110 is in communication with the computing device 108 via the network 104 configured to store a plurality of trade finance transaction documents.

In one embodiment, the computing device 108 comprises at least one processor and a memory in communication with the processor. The memory stores a set of instructions executable by the processor. In one embodiment, the computing device 108 receives the trade finance transaction documents uploaded by the user or any of transactional entities via the network 104 configured to classify the trade finance transaction documents under different groups/categories using at least one artificial intelligence classifier; preview each page of the document as per letter of credit (LC); verify the system extracted information from the uploaded documents, and validate one or more rules for each document to provide document scrutinization results based on Uniform Customs and Practice (UCP)/International Standard Banking Practice (ISBP)/Consistency rule checks, thereby performing automated reconciliation against UCP and ISBP rules and seamlessly integrate with sanctions screening and Trade Based Money Laundering (TBML) systems.

In one embodiment, the computing device 108 may be a server or cloud server. The server is configured to collect one or more parameters from the user device 102. In one embodiment, the server may be operated as a single computer. In some embodiments, the computer could be a touchscreen and/or non-touchscreen and adopted to run on any type of OS, such as iOS™, Windows™, Android™, Unix™, Linux™, and/or others. In one embodiment, the plurality of computers is in communication with each other, via the network 104. Such communication is established via a software application, a mobile app, a browser, an OS, and/or any combination thereof.

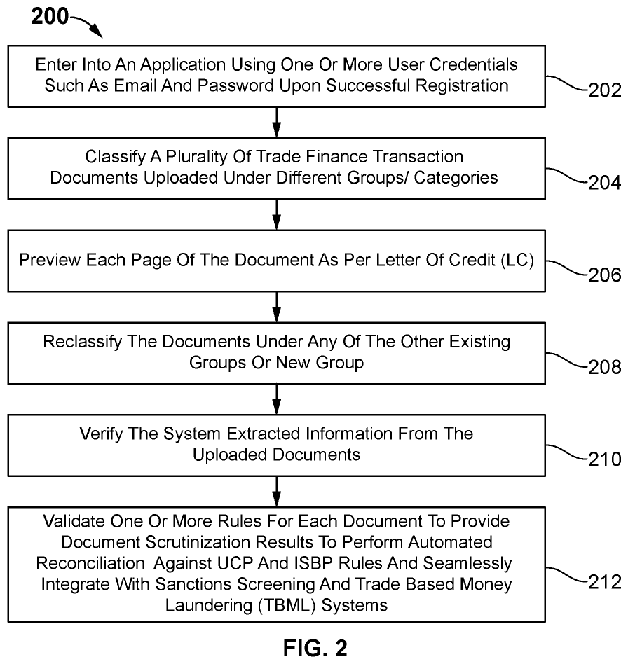

Referring to FIG. 2, a method 200 for trade finance operations and sanctions screening executed using a system in a computer-implemented environment 100, according to one embodiment of the present invention. In one embodiment, the system is an application software or mobile application or web-based application. In one embodiment, the application is executed in the computer-implemented environment or network environment 100. In one embodiment, the computer-implemented environment 100 comprises a user device 102 and a trade finance transaction management system 106. The user device 102 is associated with a user or maker or banker. The user device 102 is enabled to access the trade finance transaction management system 106 via a communication network 104. In one embodiment, the trade finance transaction management system 106 comprises a computing device 108 and one or more databases 110. In one embodiment, the user device 102 comprises a storage medium in communication with the network 104 to access the computing device 108 via the network 104 configured to perform finance operations and sanctions screening operation. In one embodiment, the computing device 108 comprises at least one processor and a memory in communication with the processor. The memory stores a set of instructions executable by the processor.

In one embodiment, the method 200 comprises the following steps. At step 202, the user log in/sign in to enter in to the application using one or more user credentials such as email and password upon successful registration. At step 204, the system classifies a plurality of trade finance transaction documents uploaded under different groups/categories. At step 206, the system allows the user to preview each page of the document as per letter of credit (LC). At step 208, the documents are reclassified under any of the other existing groups or a new group. At step 210, the system enables the user to verify the system extracted information from the uploaded documents. In one embodiment, the system compares each document with LC that allows the user to cross-verify the contents of the document against the values in the LC from the same page. At step 212, one or more rules are validated for each document to provide document scrutinization results based on Uniform Customs and Practice (UCP)/International Standard Banking Practice (ISBP)/Consistency rule checks, thereby performing automated reconciliation against UCP and ISBP rules and seamlessly integrate with sanctions screening and Trade Based Money Laundering (TBML) systems.

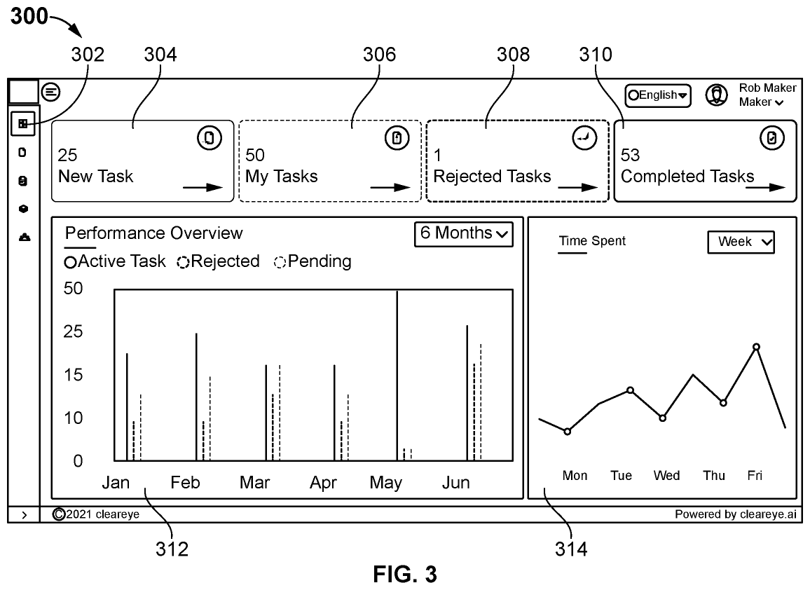

Referring to FIG. 3, a screenshot 300 of a dashboard 302 of a user, according to one embodiment of the present invention. In one embodiment, the screenshot 300 comprises a profile for each user having a representation of task history of a corresponding transactional entity. The dashboard 302 contains a plurality of tasks categorized under different categories. In one embodiment, the dashboard 302 has one or more categories to categorize the tasks. In one embodiment, the tasks are categorized as new tasks/new jobs 304, assigned task/my tasks 306, rejected tasks 308, and completed tasks 310. Each category has different colors for easy access. In one embodiment, the dashboard 302 further comprises one or more graphical representations to demonstrate performance overview graph 312 and time spent graph 314. The performance overview graph 312 shows various tasks such as active task, rejected tasks, and pending tasks measured each month. In one embodiment, a filter may be applied to show the performance overview for about 6 months. The time spent graph 314 shows the time spent on each day to perform the tasks. In one embodiment, a filter may be applied to show the time spent for a week.

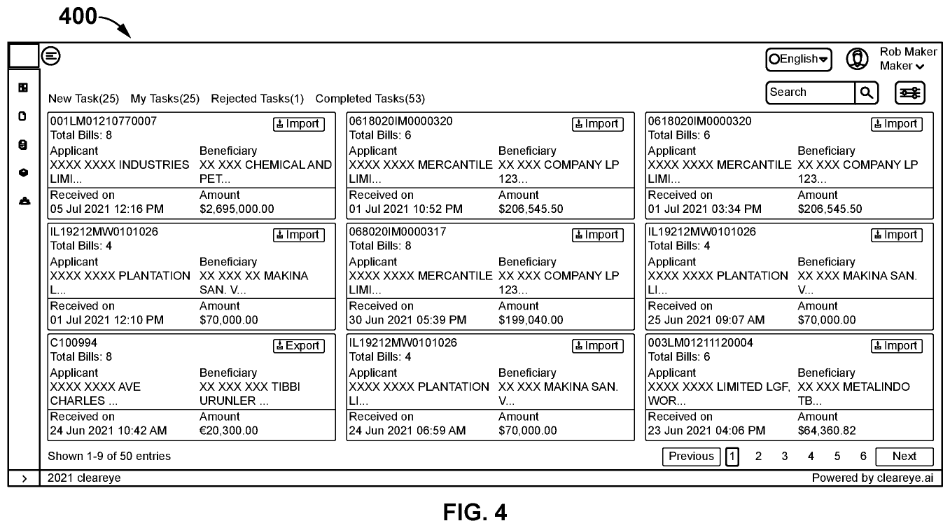

Referring to FIG. 4, a screenshot 400 showing a plurality of tasks, according to one embodiment of the present invention. Each category shows the number of tasks assigned to them. Upon selecting a particular category, it shows an expanded view of all the tasks assigned to them in one or more pages. In one embodiment, the screenshot 400 shows a plurality of tasks assigned under the assigned task/my tasks category 306.

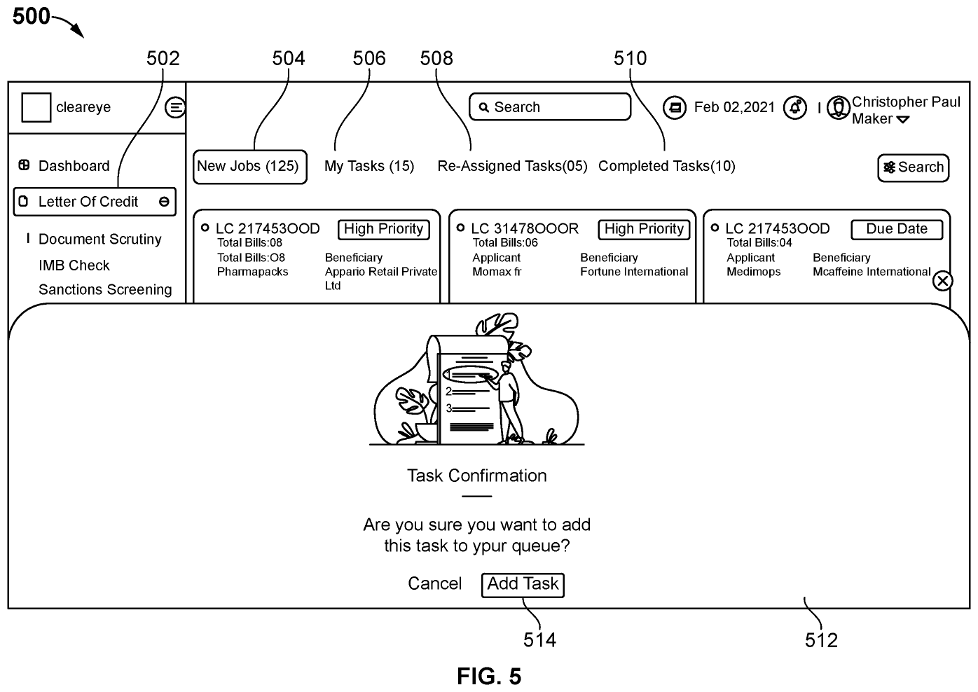

Referring to FIG. 5, a screenshot 500 for task confirmation, according to one embodiment of the present invention. The screenshot 500 includes a letter of credit 502. The letter of credit 502 comprises one or more task categories such as new jobs 504, my tasks 506, re-assigned tasks 508, and completed tasks 510. The screenshot 500 has a plurality of tasks assigned under new jobs category 504. The system will display/pop-up a task confirmation tab 512 while selecting any of the tasks. By clicking “Add Task” 514, the task will be added to the queue under my tasks 506.

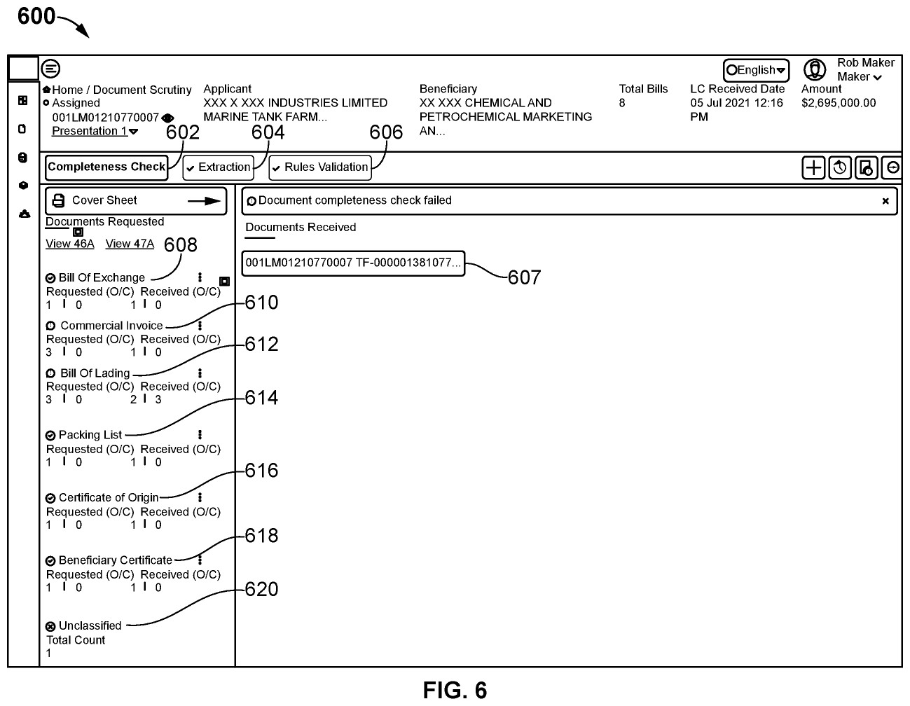

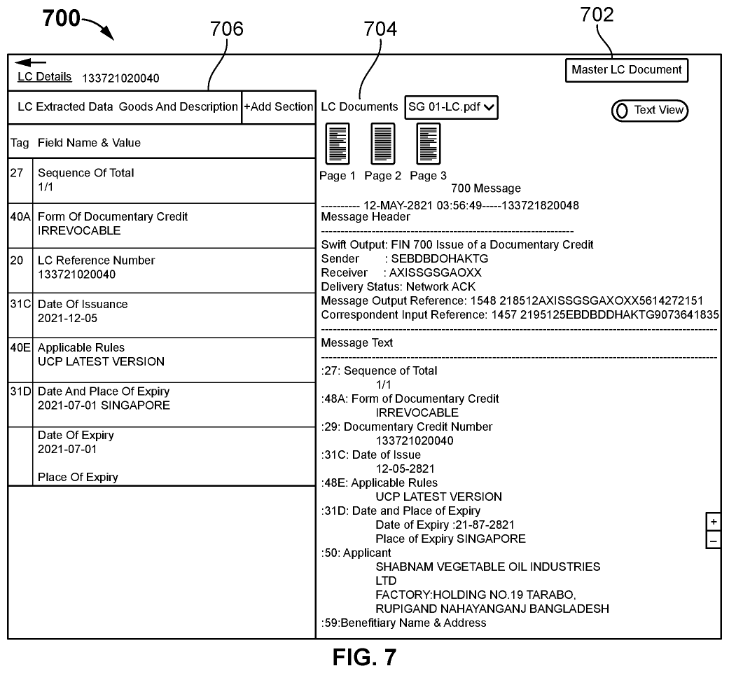

Referring to FIG. 6, a screenshot 600 of an assigned task, according to one embodiment of the present invention. The screenshot 600 shows a profile of a user with one or more user details such as user name. The assigned task has one or more sections such as LC details section, applicant section, beneficiary section, total bills, LC received date, and amount. The screenshot 600 further illustrates one or more stages include a completeness check 602, an extraction 604, and a rules validation 606. The completeness check 602 has the direct link to preview 46A and 47A conditions as given in the LC details. The system has the ability to understand the original and duplicates of the uploaded documents. This helps in cross-verifying the presence of documents as per the LC calls for in 46A/47A. The screenshot 600 comprises a received document 607 presented with the LC details (as shown in FIG. 7). Further, the completeness check 602 shows various documents requested or received by the user or other transactional entities under different fields such as bill of exchange 608, commercial invoice 610, bill of lading 612, packing list 614, certificate of origin 616, beneficiary's certificate 618, and unclassified 620.

Referring to FIG. 7, a screenshot 700 of various LC details, according to one embodiment of the present invention. The LC details include LC extracted data and LC original data. The screenshot 700 comprises a master LC document 702 and one or more LC documents 704 provided by any issuing banks. The issuing banks disclose special requirements regarding the requested documents under this field such as signature requirements, attestation requirements, date requirements, etc. as part of Field 47A. In an embodiment, an amendment to the LC signifies any change made to the terms of an LC after it has been authorized. The amendment may be made at any time after the LC has been authorized and before its expiry date. Further, a Field 45A of LC mentions description of Goods and/or Services 706.

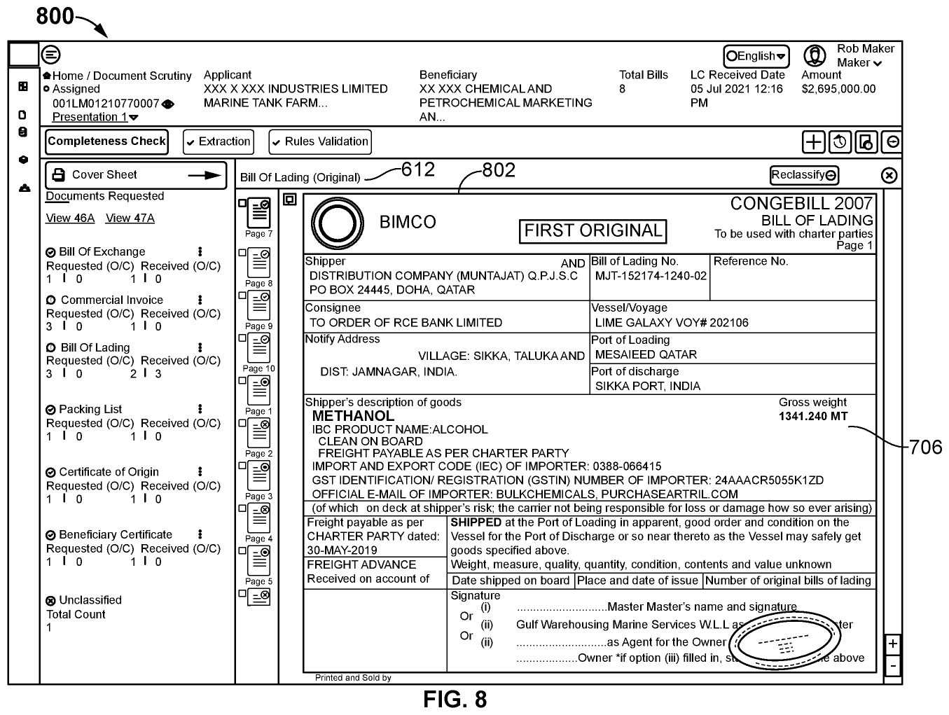

Referring to FIG. 8, a screenshot 800 showing bill of lading 612 of the assigned task, according to one embodiment of the present invention. Upon clicking bill of lading 612, the document is opened on the given field. Each page of the document may be previewed. It enables the user to preview all the pages of the document. Document preview ensures that the user/maker can review the pages classified are as per the LC. In addition, presentation documentation scrutiny also needs to be done against the LC after applying the amendments with the Master LC document. In one embodiment, the system automates the amendment handling by creating and maintaining the master LC 702 by applying amendments to the original LC 802, thereby eliminating the complex manual process to go over all the amendments that have been issued in the sequence it was issued, and figure out the clauses or tags that have been amended one by one before performing a document check. The system uses smart matching techniques to figure out the amended tags. The changes are applied by maintaining the sequence in which amendment has been generated irrespective of the order in which the system receives the amendments. When new amendments are generated, the system updates the master LC 702 and runs the document checking against the updated master LC document 702 without any user trigger.

The Field 45A of LC mentions Description of Goods and/or Services 706. According to current letter of credit rules, the description of the goods, services or performance in a commercial invoice must correspond with that appearing in the letter of credit. In documents other than the commercial invoice, the description of the goods, services, or performance, if stated, may be in general terms not conflict with their description in the credit. Not just with the description of Goods and services, consistency checks with respect to HS Code, Unit Price quantity, etc., to be performed by manually by a document examiner. As an example, as per ISBP 2007, if a trade term is part of the description of the goods in the credit, or stated in connection with the amount, the invoice must state the trade term specified, and if the description provides the source of the trade term, the same source must be identified (e.g., a credit term “CIF Singapore Incoterms 2000” would not be satisfied by “CIF Singapore Incoterms”).

According to the present invention, the system automates the consistency check as part of the offering. Also, the system solves the challenges by building a proprietary model based on natural language processing that can parse and separate tag 45A. Extension of the same model is applied to extract goods/services from invoices and packing lists irrespective of the layout/table structure. Instead of using a general-purpose entity recognition model, the system uses a model that is very specially trained in the Trade finance context for higher accuracy. Further, the system has developed custom models to perform semantic matching of Goods description texts, instead of just doing a string comparison. This approach eliminates the use of simple string match to reduce false positives.

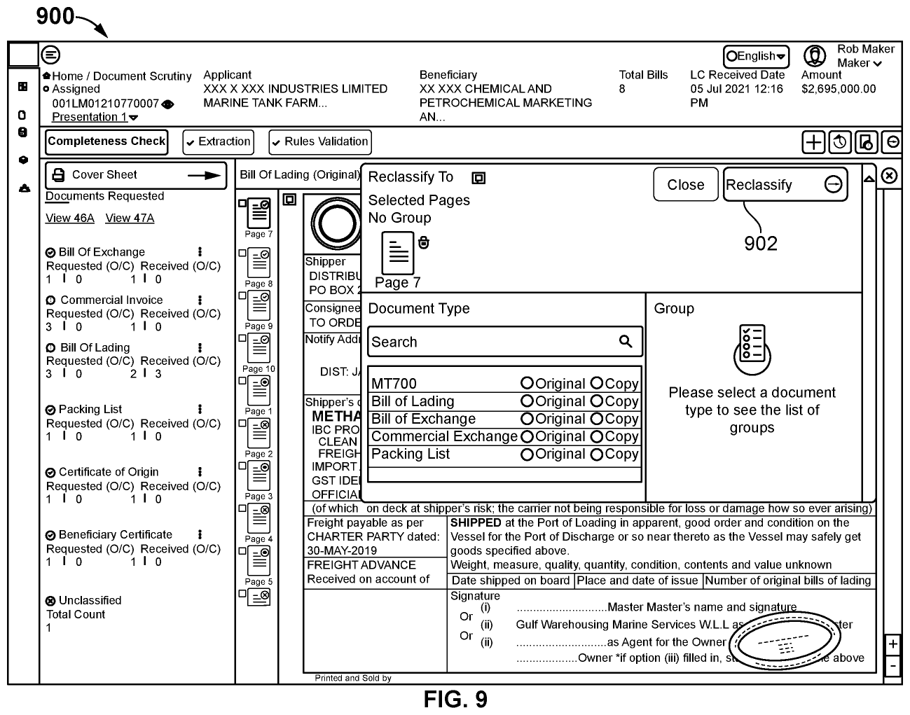

FIG. 9 shows a screenshot 900 of reclassification of the assigned task, according to one embodiment of the present invention. The screenshot 900 has a reclassify option 902 to reassign/reclassify the document to any of the other groups or a new group. The document may be assigned under different groups by selecting the document type using the search option. In one embodiment, the document may be reclassified to another group by clicking a “reclassify” tab 902. Reclassification is a unique ability that allows manual re-classification of documents during wrong classification or un-classification of the documents. This helps in the continuous training of the system.

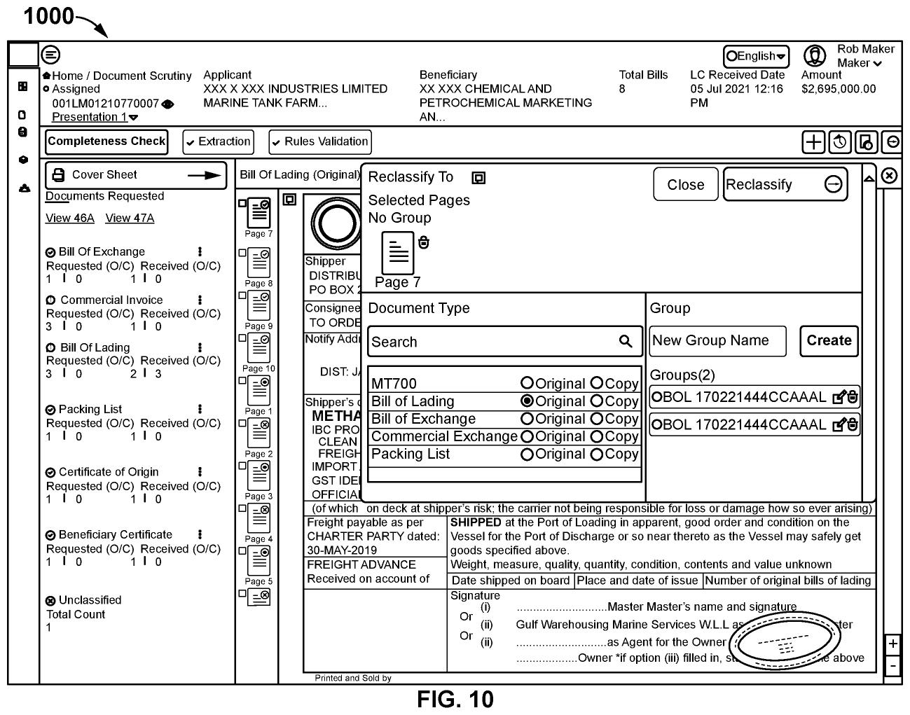

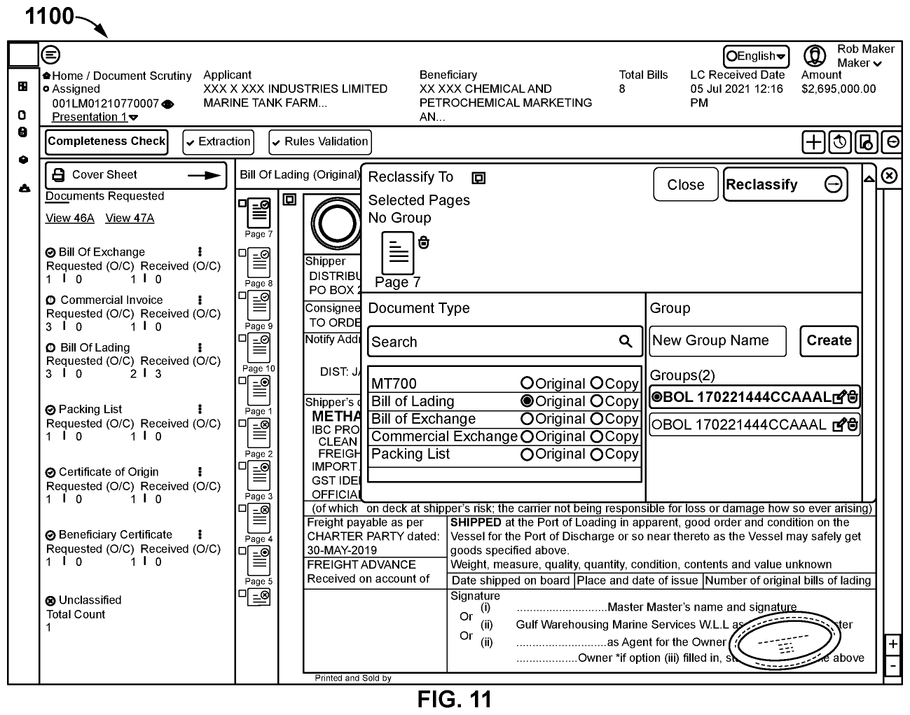

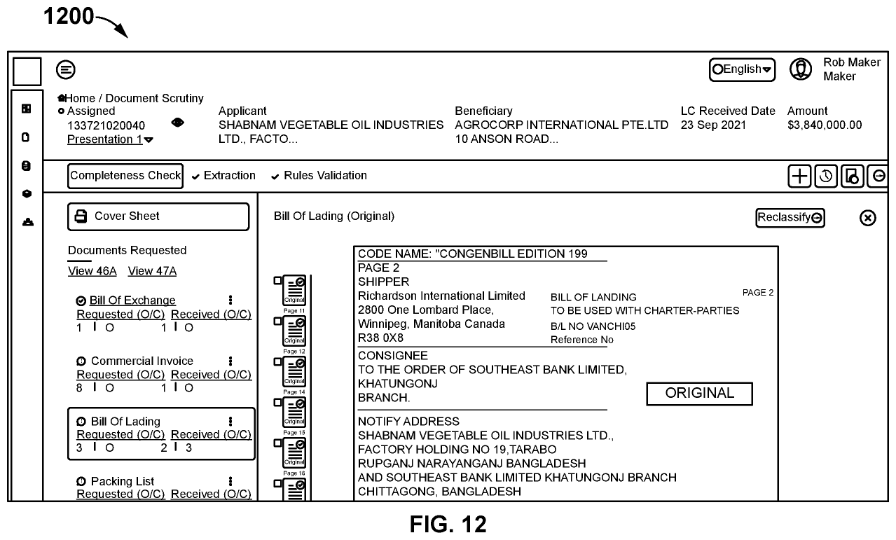

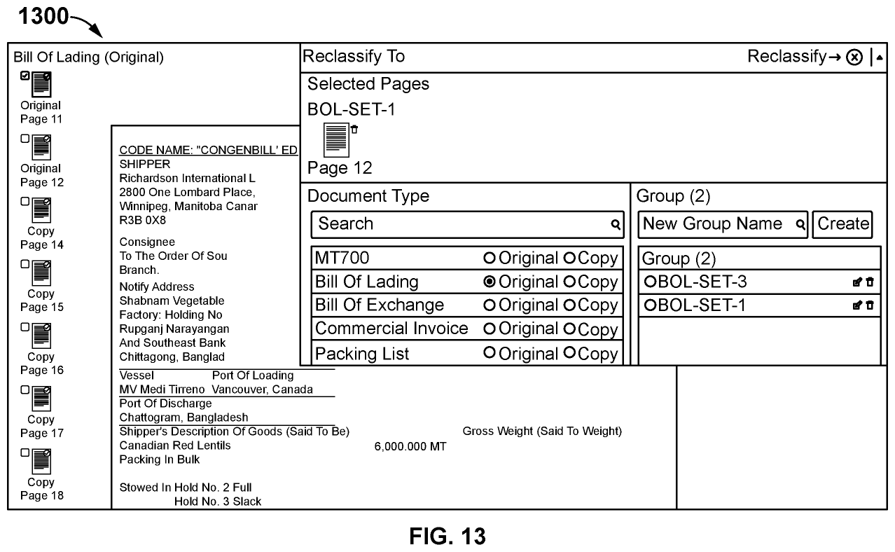

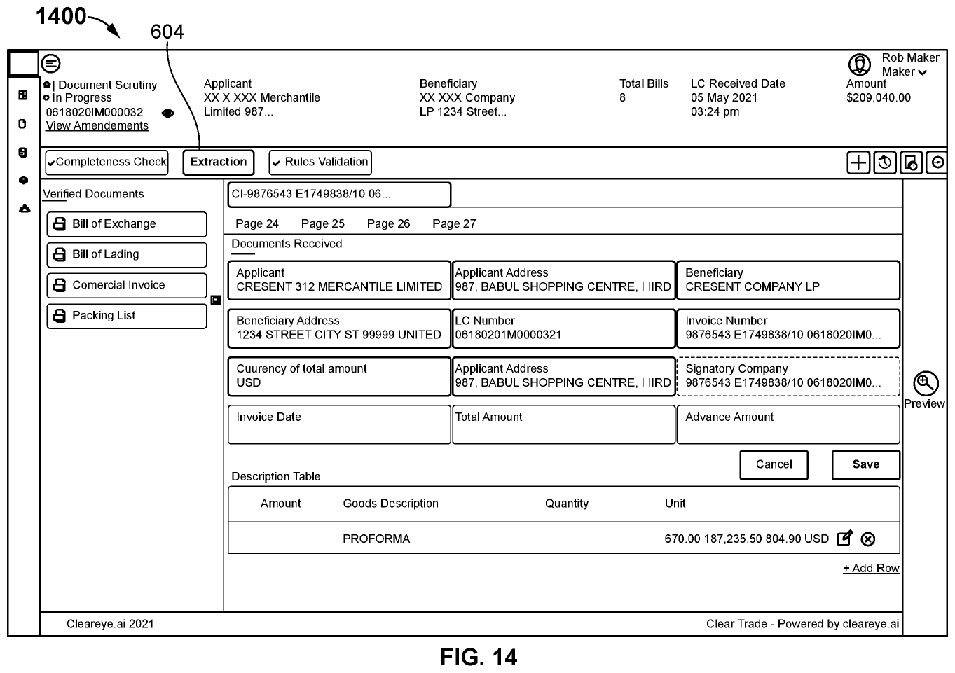

Referring to FIGS. 10-11, one or more screenshots (1000 and 1100) illustrating the reclassification of the assigned task under different groups, according to one embodiment of the present invention. Upon selecting the document type, the groups are listed. It allows the user to select any one of the listed groups or create a new group. Upon selecting the group, the task has been categorized under the selected group. FIGS. 12-13 illustrate one or more screenshots (1200 and 1300) showing an example for original data of bill of lading in one embodiment of the present invention.

Referring to FIG. 14, a screenshot 1400 of the extraction 604, according to one embodiment of the present invention. The extraction 604 has a plurality of input fields having the details of the received document. Under the extraction stage, the maker verifies the system extracted information from the documents uploaded. Each page-wise extraction is viewed and verified by the maker. To enhance the user experience, the extraction 604 is represented by the color coding around the extraction boxes based on the preset threshold values. Thus, the maker can directly focus on the items that need more attention. These changes are previewed and saved.

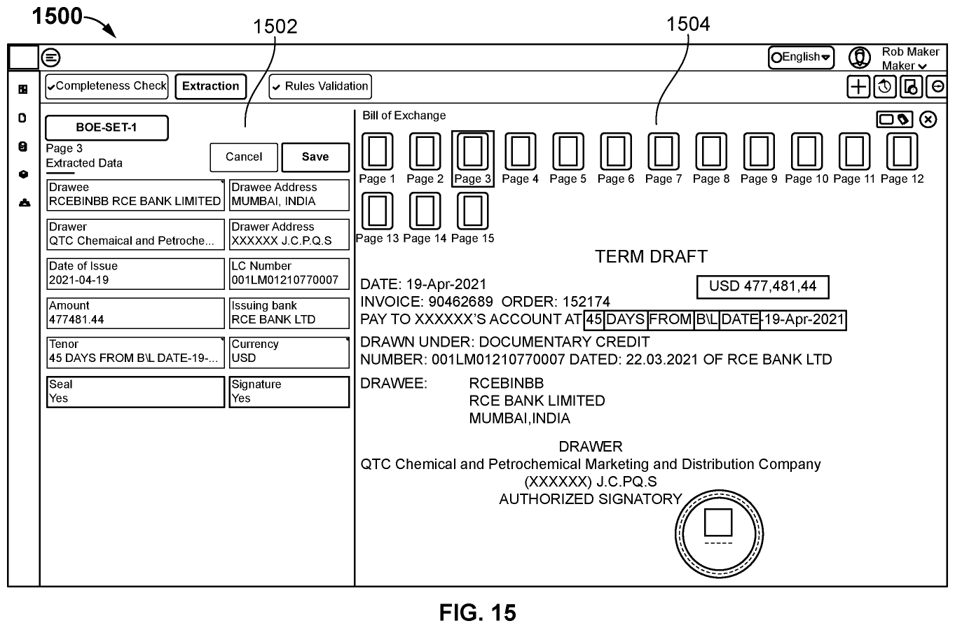

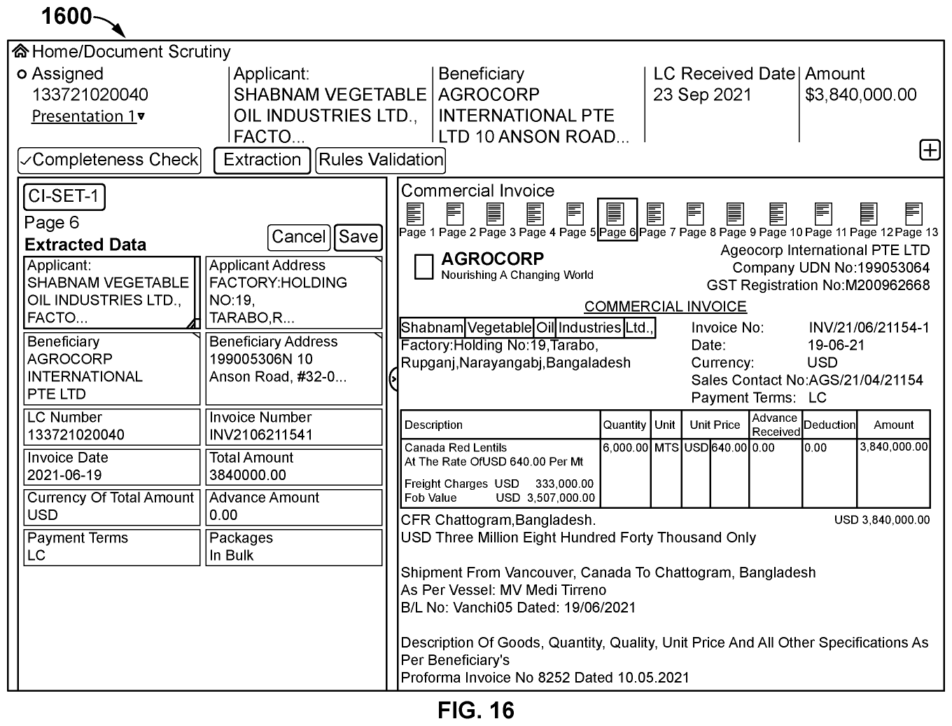

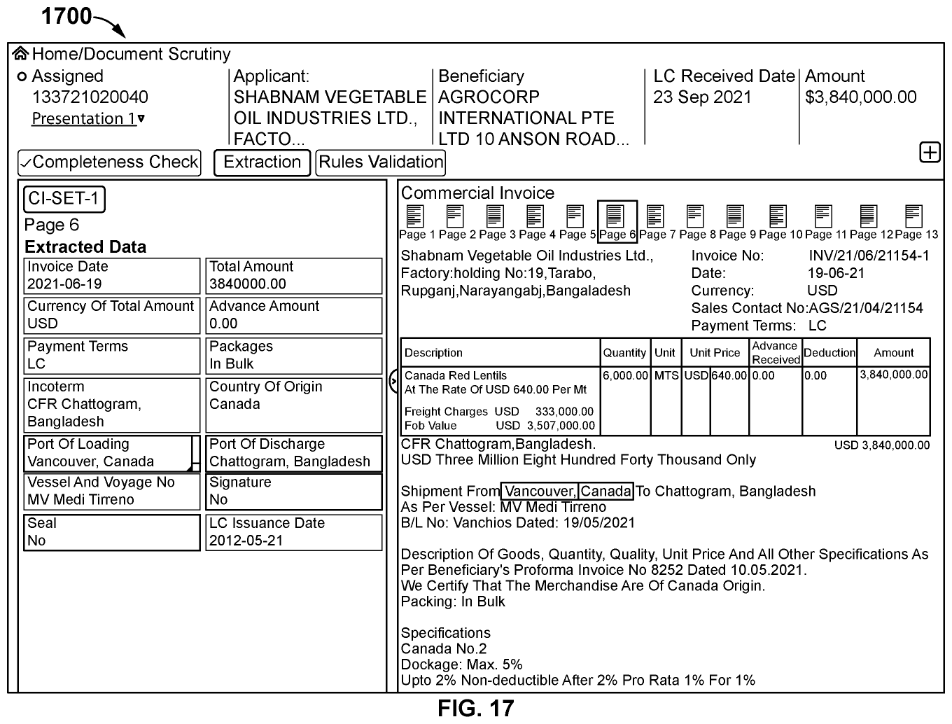

Referring to FIG. 15, a screenshot 1500 of the bill of exchange 608 under extraction 604, according to one embodiment of the present invention. The screenshot 1500 shows a data field 1502 having a plurality of extracted bill data on a first section or left side and a bill of exchange 1504 on a second section or right side. In one embodiment, the system further utilizes a rubber banding or smart data capture. The smart data capture is one of the unique features that eliminates the need for any manual typing to capture missing information from the actual document. The smart data capture enables the maker to just make a selection by clicking the button and the data on the bill of exchange 1504 on the right side, which then gets captured on the data field 1502 at the left side. FIGS. 16-17 illustrate one or more screenshots (1600 and 1700) for filling extracted bill data on the left side and the bill of exchange on the right side using the smart data capture technique.

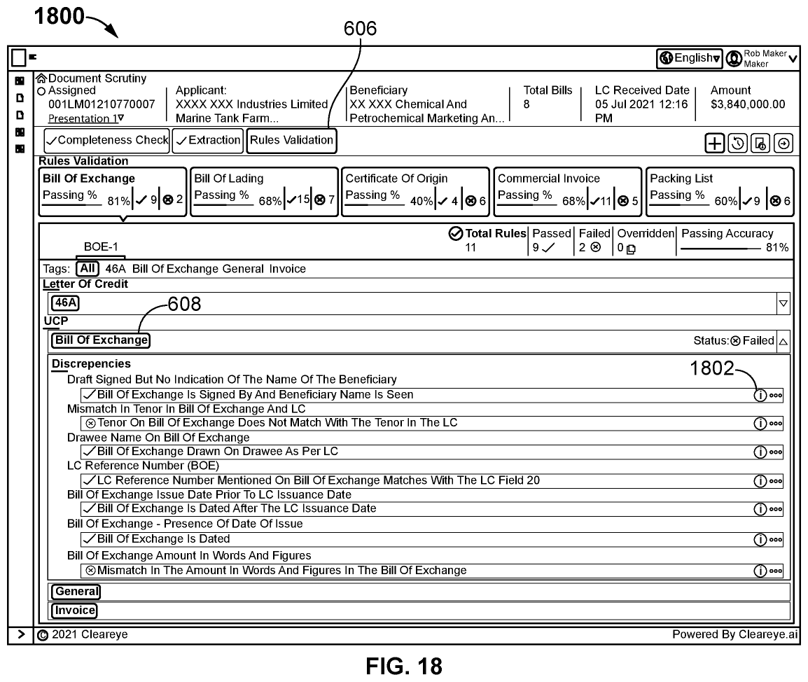

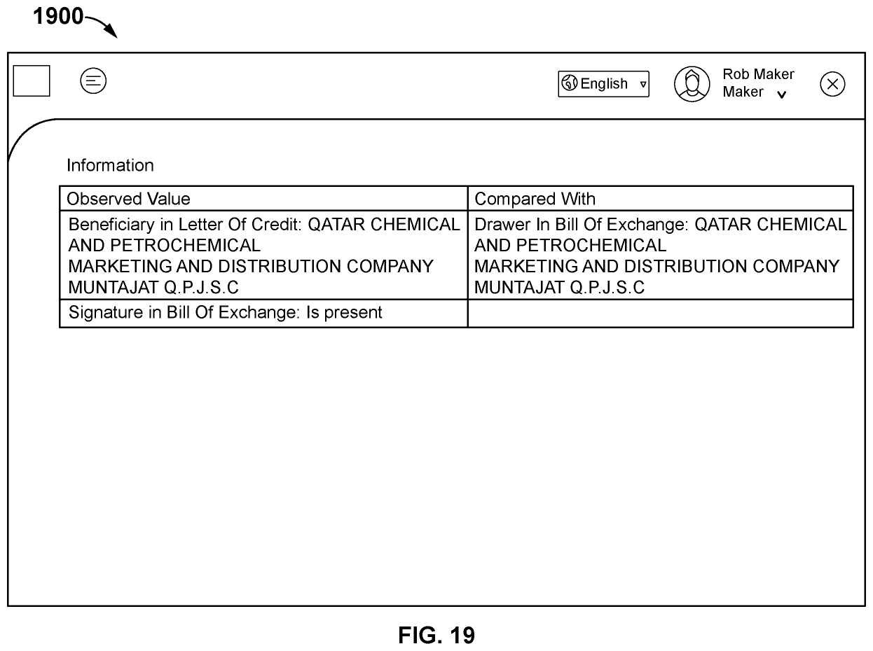

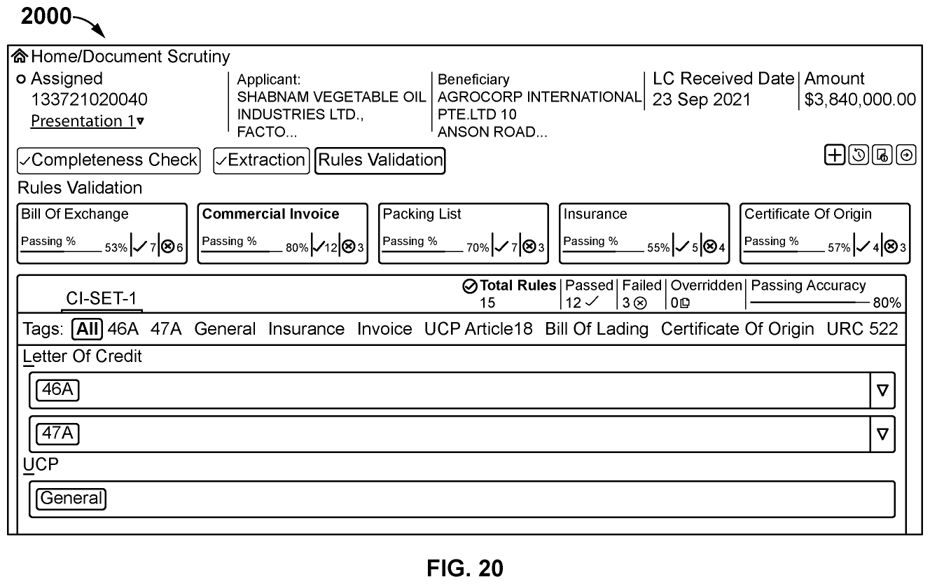

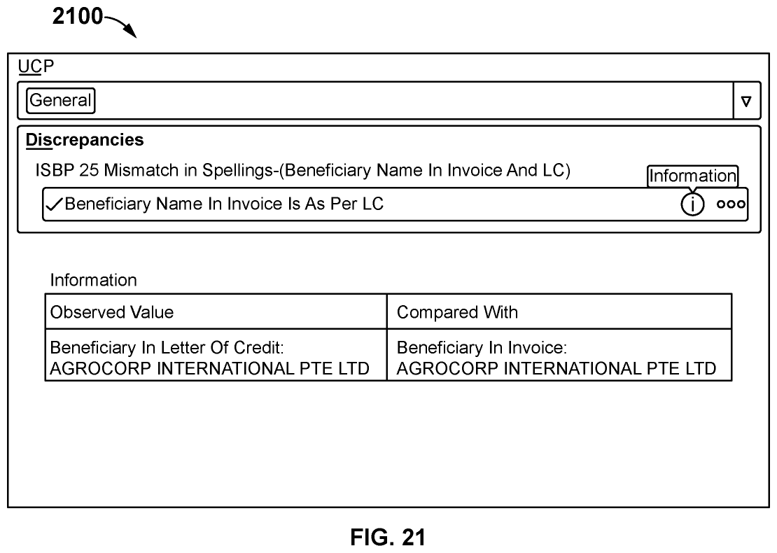

Referring to FIG. 18, a screenshot 1800 of the rules validation 606, according to one embodiment of the present invention. Rules validation is the most important stage within the system. The document scrutinization results are showcased in the rules validation based on UCP/ISBP/Consistency rule checks. The screenshot 1800 shows discrepancies for each document in individual tabs. The counts represent the total number of rules run and the pass/fail/overridden count for rules. The screenshot 1800 further shows a list of discrepancies under the bill of exchange 608. Each discrepancy has an explainability view or information 1802. The explainability view brings uniqueness and enhances the user experience while reviewing the rules validation. This gives a clear view of the values being compared and eliminates any ambiguity for rules passed or failed. The system compares the extracted data with the LC details and allows the user/maker to cross-verify the contents of the document against the values provided in the LC details. FIG. 19 shows a screenshot 1900 of a comparison table. By clicking the explainability view 1802, the comparison table shows the system extracted data compared with the LC details. FIG. 20 shows an example screenshot 2000 of rules validation, according to one embodiment of the present invention. FIG. 21 shows an example screenshot 2100 of the explainability view to display the comparison table with observed value and compared value.

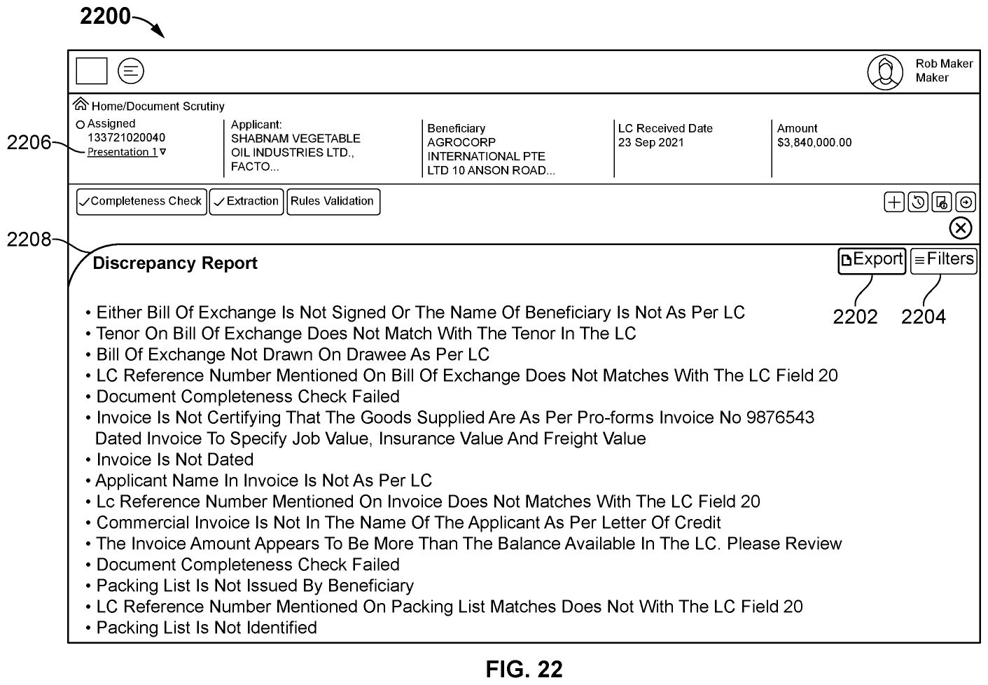

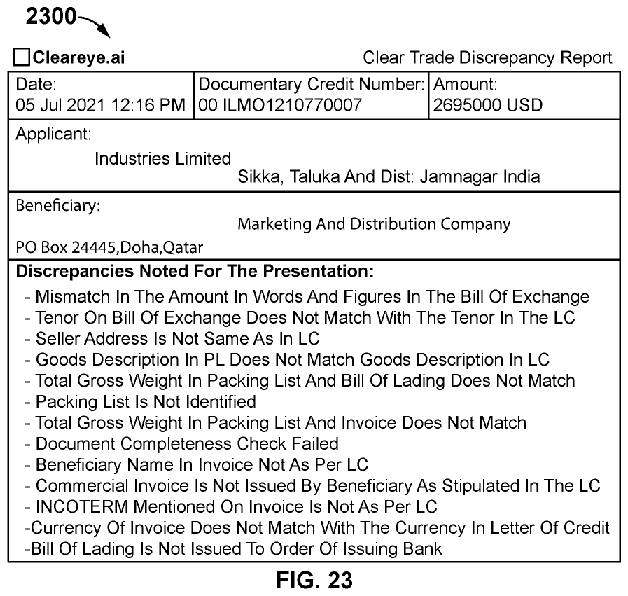

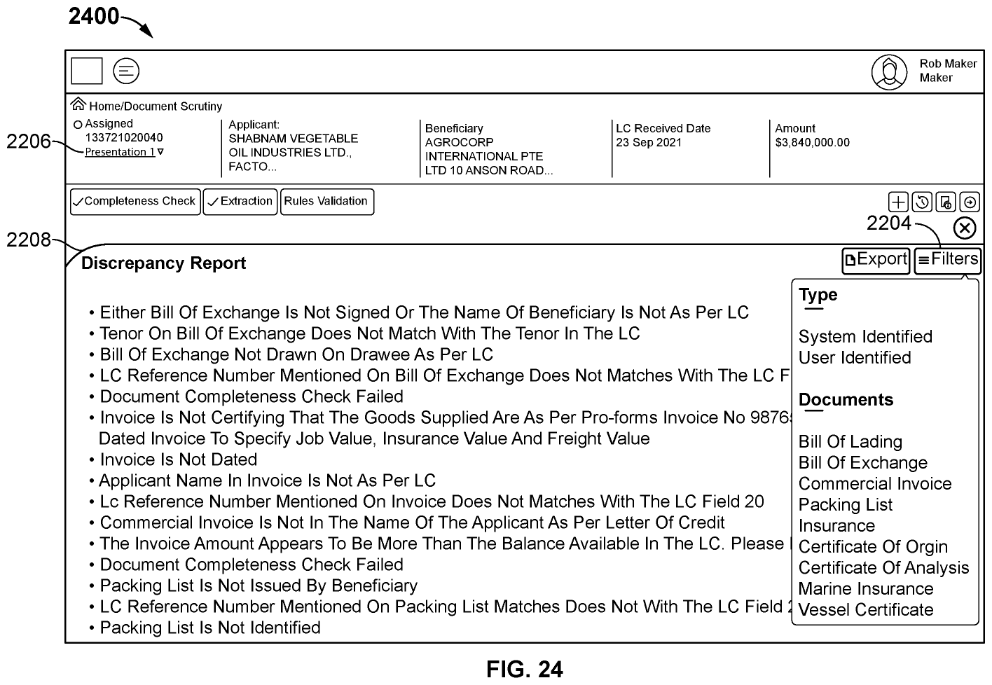

Referring to FIGS. 22-24, one or more screenshots (2200, 2300, and 2400) of a discrepancy report 2208, according to one embodiment of the present invention. The system generates a consolidated discrepancy report 2208 for the respective LC and associated trade documents. Reports may be filtered either as system identified or user identified in case of manual addition of discrepancy. The system has “Export” 2202 to export the discrepancy report 2208 as a standard format, for example, PDF as shown in FIG. 23. In one embodiment, the system further has “Filters” 2204 configured to filter the discrepancy report 2208 based on the user requirement. Upon selecting one or more options, the system re-generates the discrepancy report 2208 by applying the selected filter options.

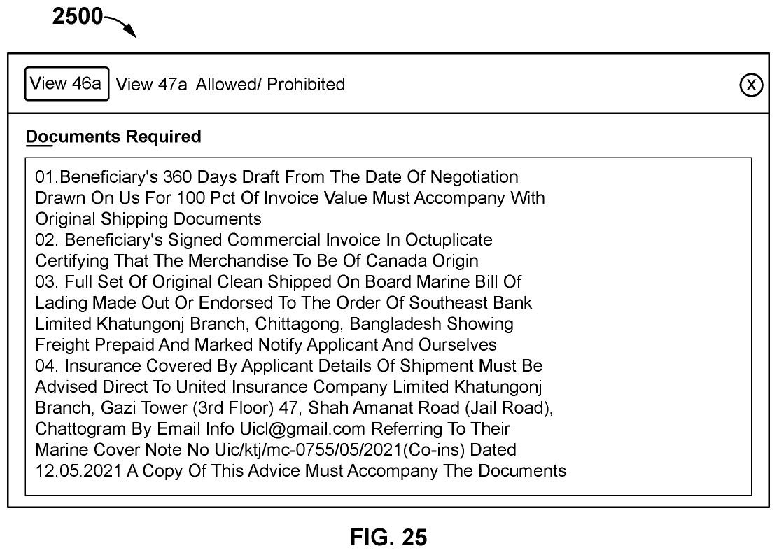

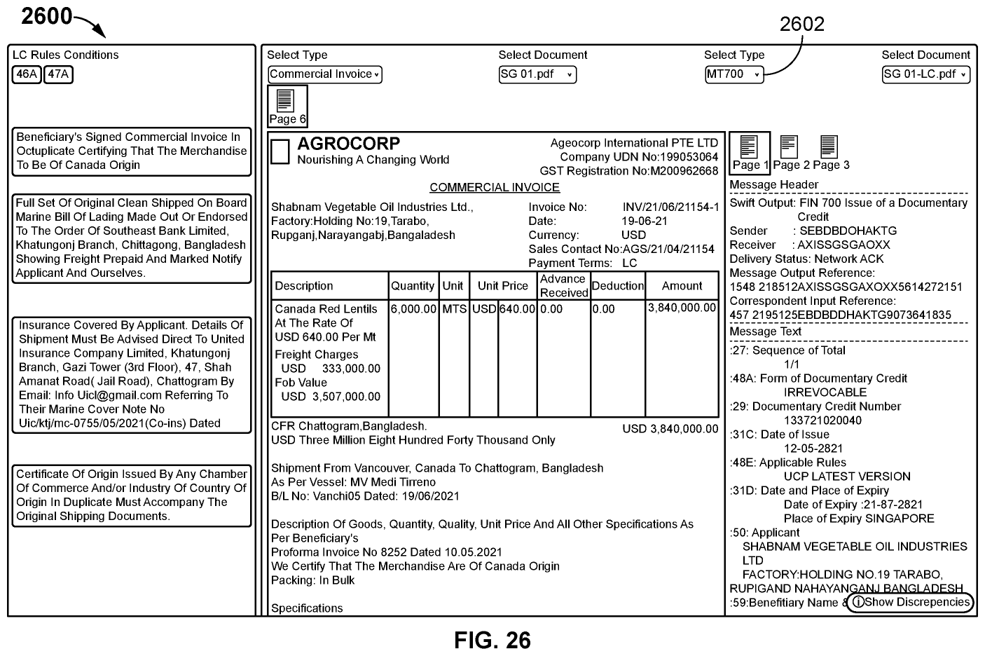

Referring to FIGS. 25-26, one or more screenshots (2500 and 2600) for highlighting passed/failed conditions, according to one embodiment of the present invention. The system enables the user to view the 46A/47A rules directly by clicking on the link. The screenshot 2600 contains LC rules conditions on the left side and the document on the right side. It enables the user to select the document type and compare with the LC details by highlighting the rule's conditions.

The screenshot 2600 contains MT 700 2602, which is a special swift message type. The MT 700 swift message type 2602 is used by issuing banks or advising banks when sending an amendment to a documentary credit. In addition, a field in MT 700 swift message type 2602 contains a description of a plurality of additional conditions of the documentary credit. Few examples include, all documents are required to be dated and signed; all documents are required to indicate the beneficiary's name; Bill of lading bearing charges additional to freight mentioned on articles 26(c) of UCP 2007 Revision Publication 600 is prohibited; and L/C reference no TF1808669450 has to be indicated on all documents except the proforma invoice. The system applies proprietary natural language process (NLP) techniques to parse the above-mentioned conditions, thereby eliminating the need for searching the above conditions line-by-line for match finding against one or more presentation documents 2206 for any discrepancies listed in a discrepancy report 2208 as shown in FIGS. 22-24. Further, the system understands the intent pr meaning and validate the presentation documents 2206 against the above-mentioned conditions in an automated manner.

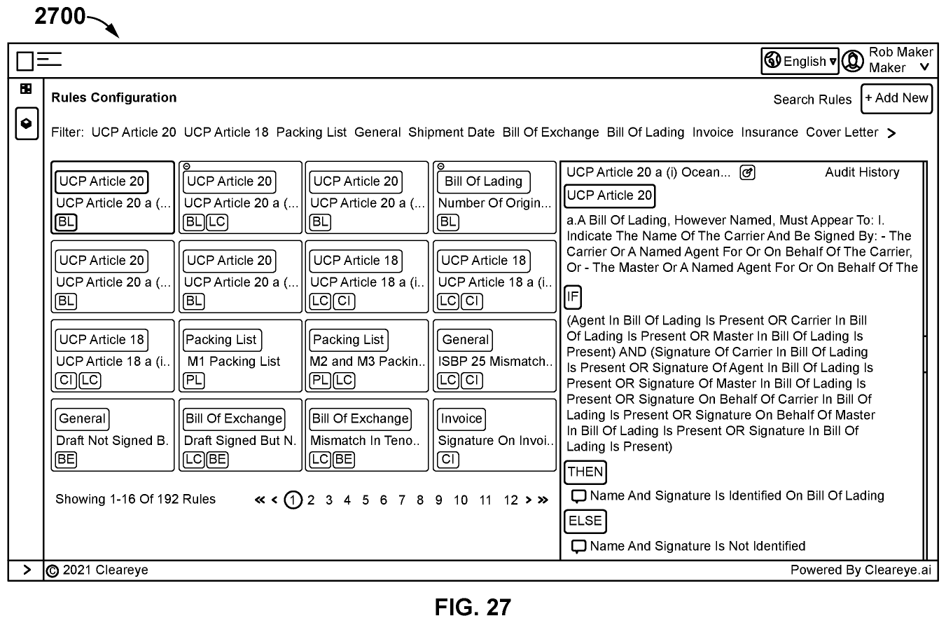

Referring to FIG. 27, a screenshot 2700 of rules configuration, according to one embodiment of the present invention. The system enables the user to log in/sign in to enter in to the rules configuration. The system contains UCP/ISBP/Generic consistency rules check authored in the rules engine. These rules can be enabled/disabled based on a business requirement. The system allows the user to create/add a new rule.

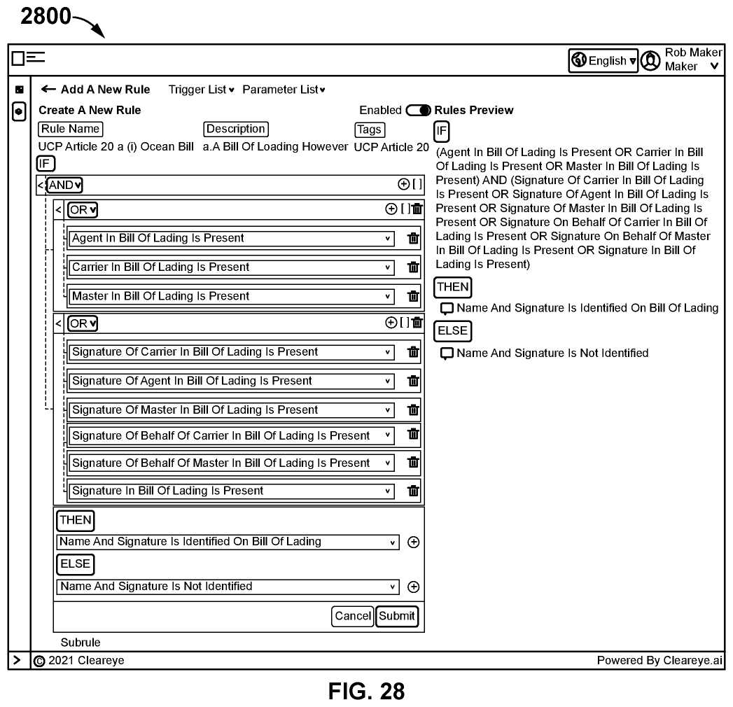

Referring to FIG. 28, a screenshot 2800 illustrates addition of a new rule, according to one embodiment of the present invention. In one embodiment, the system provides the rules authoring capability to any business user, which gives more transparency towards the rules executed in the context of trade document scrutinization. The business user may author relevant rules using the parameters and triggers supported by the system. Each rule has a rule name, description, and tag. Each rule is framed with one or more operators. The system further has a rule preview option. The rules preview explains the rules authored and the operators used to derive the rules check when executed.

Advantageously, the system of the present invention leverages advanced artificial intelligence (AI) techniques to improve the effectiveness and efficiency of the trade finance operations and sanctions screening processes. The system enables the clients to reduce risks, improve throughput by up to 70% and significantly reduce false positives and missed red flags. The system performs an automated classification, extraction, and validation of information from low fidelity scanned images or documents using layout and position-based learning. The system performs automated interpretation of Letter of Credit (LC) conditions using natural language processing (NLP). The system automates the reconciliation against UCP and ISBP. The improved transaction increases the productivity to about 70% and significantly reduces the false positives in sanctions screening. Further, the system drastically reduces the missed red flags in TBML checks and improves the risk coverage and compliance level.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A computer-implemented system for trade finance operations and sanctions screening, comprising:
a computing device having at least one processor and a memory in communication with the processor, wherein the memory stores a set of instructions executable by the processor;
one or more databases in communication with the computing device via a network configured to store a plurality of trade finance transaction documents, and
a user device associated with a user in communication with the computing device via the network configured to perform finance operations and sanctions screening,
wherein the computing device receives the trade finance transaction documents uploaded by the user or any of transactional entities via the network configured to,
classify the trade finance transaction documents under different groups/categories using at least one artificial intelligence (AI) classifier;
preview each page of the document as per letter of credit (LC);
verify the system extracted information from the uploaded documents, and
validate one or more rules for each document to provide document scrutinization results based on Uniform Customs and Practice (UCP)/International Standard Banking Practice (ISBP)/Consistency rule checks, thereby performing automated reconciliation against UCP and ISBP rules and seamlessly integrate with sanctions screening and Trade Based Money Laundering (TBML) systems.

2. The system of claim 1, wherein the user device is configured to communicate with the computing device via the network using an application software or mobile application or web-based application or desktop application executed in a computer-implemented environment or network environment.

3. The system of claim 1, allows the user to register into the system using one or more user credentials to access the services provided by the computing device.

4. The system of claim 1, wherein the user device is enabled to access a trade finance management system via the network.

5. The system of claim 1, wherein the user device is any one of a smartphone, a mobile phone, a laptop, a desktop, a tablet, or other suitable mobile and/or handheld electronic communication devices.

6. The system of claim 1, wherein the documents are reclassified to any of the other existing groups or a new group.

7. The system of claim 1, further performs completeness check for various documents requested or received by the user or other transactional entities under different fields.

8. The system of claim 7, wherein the different fields include bill of exchange, commercial invoice, bill of lading, packing list, certification of origin, beneficiary's, and unclassified.

9. The system of claim 1, further utilizes rubber banding or smart data capture configured to eliminate the need for any manual typing to capture missing information from the actual document.

10. The system of claim 1, compares each document with LC allows the user to cross-verify the contents of the document against the values in the LC from the same page.

11. The system of claim 1, generates a discrepancy report for the respective LC and associated trade documents and exports the discrepancy report in a standard format.

12. The system of claim 1, provides the rules authoring capability to any user that gives more transparency towards the rules executed in the context of trade document scrutinization.

13. The system of claim 1, further includes a profile comprising a representation of task history of a corresponding transactional entity.

14. A method for trade finance operations and sanctions screening executed in a computer-implemented system having a computing device that includes a processor and a memory in communication with the processor, wherein the memory stores a set of instructions executable by the processor; one or more databases in communication with the computing device via a network configured to store a plurality of trade finance transaction documents, and a user device associated with a user in communication with the computing device via a network configured to perform finance operations and sanctions screening, comprising:
classifying a plurality of trade finance transaction documents uploaded under different groups/categories;
previewing each page of the document as per letter of credit (LC);
reclassifying the documents under any of the other existing groups or a new group;
verifying the system extracted information from the uploaded documents, and
validating one or more rules for each document to provide document scrutinization results based on Uniform Customs and Practice (UCP)/International Standard Banking Practice (ISBP)/Consistency rule checks, thereby performing automated reconciliation against UCP and ISBP rules and seamlessly integrate with sanctions screening and Trade Based Money Laundering (TBML) systems.

15. The method of claim 14, wherein the documents are reclassified to any of the other existing groups or a new group.

16. The method of claim 14, further performs completeness check for various documents requested or received by the user or other transactional entities under different fields.

17. The method of claim 14, further utilizes rubber banding or smart data capture configured to eliminate the need for any manual typing to capture missing information from the actual document.

18. The method of claim 14, compares each document with LC and allows the user to cross-verify the contents of the document against the values in the LC from the same page.

19. The method of claim 14, generates a discrepancy report for the respective LC and associated trade documents and exports the discrepancy report in a standard format.

20. The method of claim 14, provides the rules authoring capability to any user to provide more transparency towards the rules executed in the context of trade document scrutinization.
